(19) United States
(12) Patent Application Publication
(10) Pub. No.: US 2015/0035957 A1
(43) Pub. Date: Feb. 5, 2015

(54) DISPLAY SYSTEM AND DISPLAYING METHOD FOR DISPLAY SYSTEM

(71) Applicant: HON HAI PRECISION INDUSTRY CO., LTD., New Taipei (TW)

(72) Inventor: YI-ZHONG SHEU, New Taipei (TW)

(21) Appl. No.: 14/444,381

(22) Filed: Jul. 28, 2014

(30) Foreign Application Priority Data
Aug. 1, 2013 (TW) 102127557

(51) Int. Cl. H04N 13/04; H04N 5/60

(52) U.S. Cl. CPC H04N 13/0438; H04N 5/607; H04N 5/602
USPC 348/56

(57) ABSTRACT

Display system includes a processor, a display module, and a number of shutter glasses. The processor can integrate video signals of different channels into an integrated video signal, thus the display module can display the video signals of the different channels orderly in a sequence according to a predetermined cycling period, and viewers wearing different pair of shutter glasses can watch their own specific programs. In this way, different viewers can watch different programs from the different channels through the same display system substantially at the same time.

### FIELD

The present disclosure relates to a display system and a displaying method for the display system.

### BACKGROUND

Display systems, such as televisions, allow viewers to only view one program from one channel at a time. When multiple viewers want to view different TV programs from different channels at the same time, multiple televisions may be needed.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a diagrammatic view of a display system according to an exemplary embodiment of the present disclosure, including a number of pairs of shutter glasses.

FIG. 2 is a diagrammatic view of programs from two different channels displayed by the display system of FIG. 1, according to a first exemplary embodiment.

FIG. 3 is a sequence chart of video signals displayed by the display system according to the first exemplary embodiment.

FIG. 4 is a sequence chart of two pairs of shutter glasses of the display system according to the first exemplary embodiment.

FIG. 5 is a diagrammatic view of programs from four different channels displayed by the display system of FIG. 1, according to a second exemplary embodiment.

FIG. 6 is a sequence chart of video signals displayed by the display system according to the second exemplary embodiment.

FIG. 7 is a sequence chart of four pairs of shutter glasses of the display system according to the second exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a number of mean” “at least two.” The references “outside” refer to a region that is beyond the outermost confines of a physical object. The references “substantially” are defined to be essentially conforming to the particular dimension, shape or other word that substantially modifies, such that the component need not be exact. The references “comprising,” when utilized, mean “including, but not necessarily limited to”; it specifically indicates open-ended inclusion or membership in the so-described combination, group, series and the like.

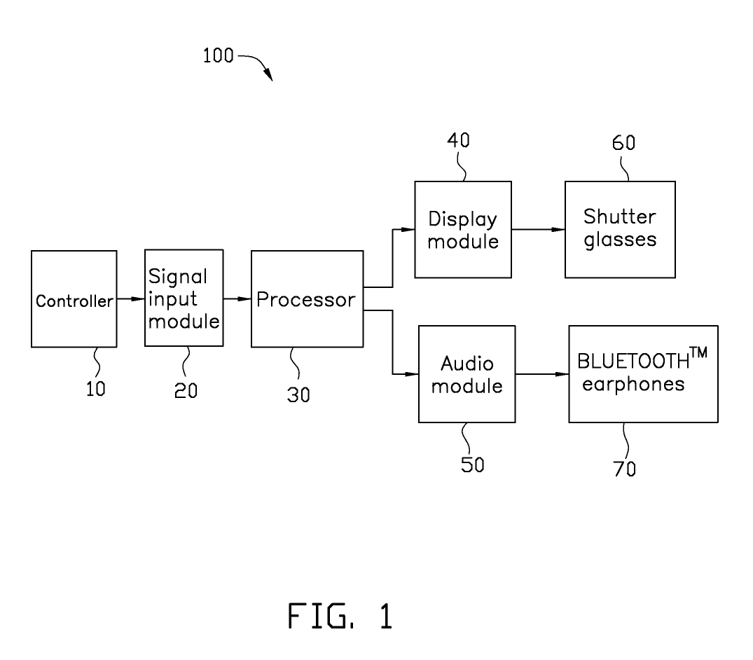

FIG. 1 illustrates an exemplary embodiment of a display system 100. The display system 100 includes a controller 10, a signal input module 20, a processor 30, a display module 40, an audio module 50, a number of shutter glasses 60 and a number of BLUETOOTH™ earphones 70.

The controller 10 receives control information from viewers. Viewers can input the control information, such as a selection of channels or programs, into the controller 10 using a remote control. Then, the controller 10 identifies the control information, controls the display system 100 to work according to the control information and controls the signal input module 20 to receive program signals of the selected channels. In this embodiment, the selected channels transmit program signals of different programs at the same time. Each channel transmits both video signals and audio signals. That is, program signals of each channel include both video signals and audio signals.

The signal input module 20 receives the program signals from the selected channels and outputs the program signals to the processor 30. The program signals from each channel are continuous. In detail, the video signals and the audio signals from each channel are continuous.

The processor 30 is configured to process the program signals from selected channels and integrate the video signals of different channels into integrated video signals. In the integrated video signals, the video signals of different channels are pieced together and are orderly integrated into a sequence according to a predetermined cycling period. The processor 30 outputs the integrated video signals to the display module 40 and controls the display module 40 to display the integrated video signals. At the same time, the processor 30 processes the audio signals from the selected channels and outputs the audio signals to the audio module 50, thus controlling the audio module 50 to transmit the audio signals of different channels.

The display module 40 is configured to display programs according to the integrated video signals from the processor 30. In detail, the display module 40 displays the video signals of different channels orderly in a sequence according to the predetermined cycling period. The predetermined cycling period is short enough that the program from each channel can be seen as being displayed continuously. In general, the predetermined cycling period is no more than 1/48 seconds, that is, the video signals of each channel should be displayed with a frequency of more than 48 hertz.

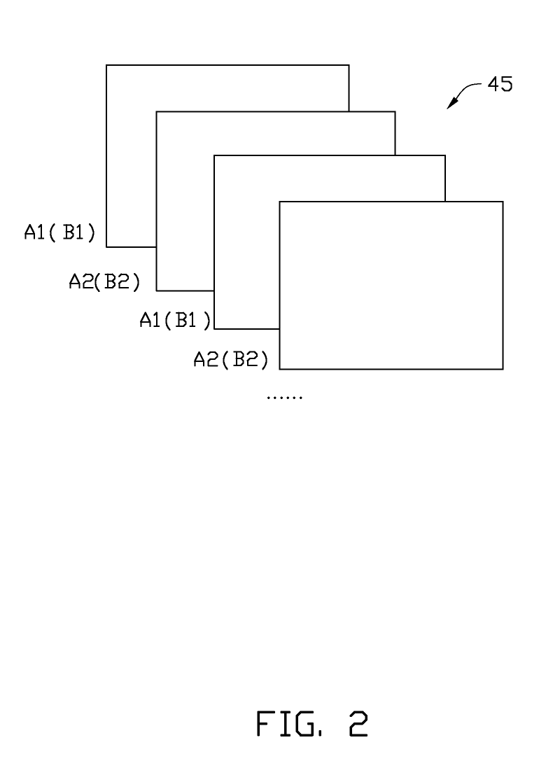

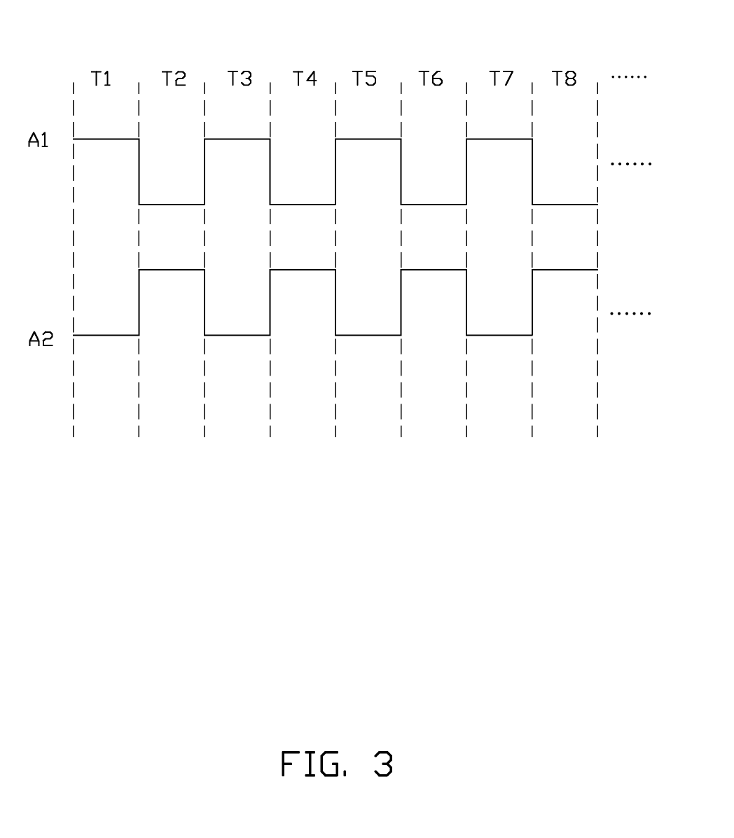

FIG. 2 shows a diagrammatic view of two programs from two different channels displayed by the display system 100 of FIG. 1, according to a first exemplary embodiment. The two programs include first program signals and second program signals. In this embodiment, the first program signals are different from the second program signals. The first program signals include first video signals A1 and first audio signals B1. The second program signals include second video signals A2 and second audio signals B2. In this embodiment, the first video signals A1 and the second video signals A2 are integrated into first integrated video signals. The display module 40 includes a display screen 45. The display screen 45 displays the first integrated video signals. In this way, the first video signals A1 and the second video signals A2 are pieced together and are orderly displayed in a sequence according to a first predetermined cycling period. In this embodiment, the first predetermined cycling period is 1/60 seconds, that is, the first video signals A1 are displayed with a frequency of 60 hertz, and the second video signals A2 are displayed with a frequency of 60 hertz. In this embodiment, a refresh frame frequency of the display screen 45 is 120 hertz. FIG. 3 is a sequence chart of the first video signals A1 and the second video signals A2. The display screen 45 displays the first video signals A1 during time period T1, T3, T5, T7 . . . Tx, wherein the subscript x is an odd number. The display screen 45 displays the second video signals A2 during time period T2, T4, T6, T8 . . . Ty, wherein the subscript y is an even number (the time period Tx and the time period Ty are not labeled in the figures). The time period T1, T2, T3, T4, T5, T6, T7, T8 . . . Tx, Ty are continuously ordered in a sequence. In this embodiment, each time period (T1, T2, T3, T4, T5, T6, T7, T8 . . . Tx, Ty) lasts 1/120 seconds.

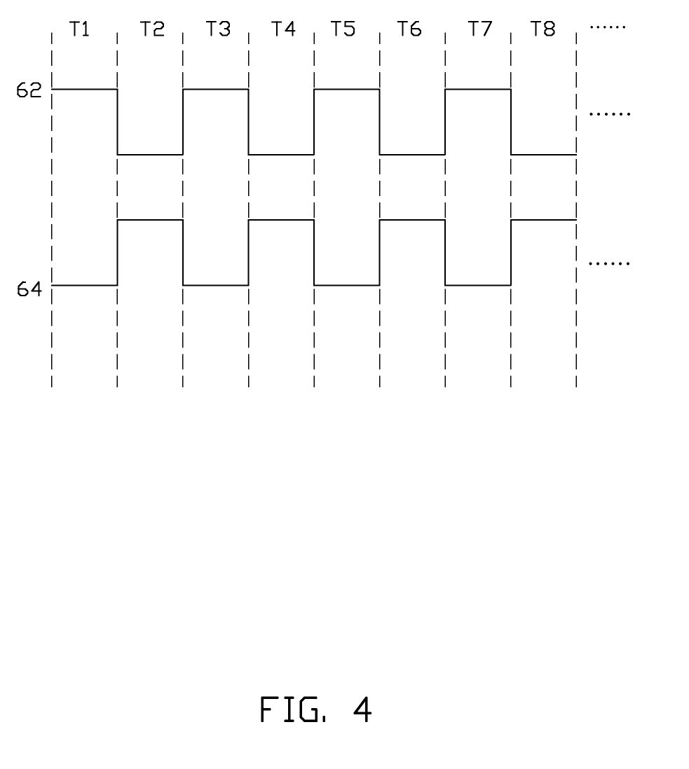

In this embodiment, there are two pairs of shutter glasses. FIG. 4 is a sequence chart of the two pairs of shutter glasses according to the first exemplary embodiment. The shutter glasses 60 include a first pair of shutter glasses 62 for watching one of the programs and a second pair of shutter glasses 64 for watching the other programs. The first pair of shutter glasses 62 and the second pair of shutter glasses 64 alternately open according to the first predetermined cycling period. In detail, the first pair of shutter glasses 62 opens during the time period T1, T3, T5, T7 . . . Tx, while the second pair of shutter glasses 64 is closed during the time period T1, T3, T5, T7 . . . Tx. The second pair of shutter glasses 64 opens during the time period T2, T4, T6, T8 . . . Ty, while the first pair of shutter glasses 62 is closed during the time period T2, T4, T6, T8 . . . Ty. The first pair of shutter glasses 62 corresponds to the first video signals A1, therefore, viewer wearing the first pair of shutter glasses 62 can watch the first video signals A1. The second pair of shutter glasses 64 corresponds to the second video signals A2, therefore, viewer wearing the second pair of shutter glasses 64 can watch the second video signals A2. In this embodiment, the processor 30 can output two synchronized signals into the first pair of shutter glasses 62 and the second pair of shutter glasses 64, respectively. Thus making the first pair of shutter glasses 62 open when the first video signals A1 are being displayed and making second pair of shutter glasses 64 open when the second video signals A2 are being displayed. The first predetermined cycling period is short enough that video signals of each program can be seen as being displayed continuously. That is, the viewer wearing one of the pairs of shutter glasses can see the video signals of a corresponding program being displayed continuously.

The audio module 50 is configured to transmit the first audio signals B1 and the second audio signals B2 to the BLUETOOTH™ earphones 70. The BLUETOOTH™ earphones 70 include a first BLUETOOTH™ earphone and a second BLUETOOTH™ earphone accordingly (the first BLUETOOTH™ earphone and the second BLUETOOTH™ earphone are not labeled in the figures). The first BLUETOOTH™ earphone is configured to receive the first audio signals B1. The second BLUETOOTH™ earphone is configured to receive the second audio signals B2. The viewer should wear the BLUETOOTH™ earphone that corresponds with the first pair of shutter glasses 62 or the second pair of shutter glasses 64.

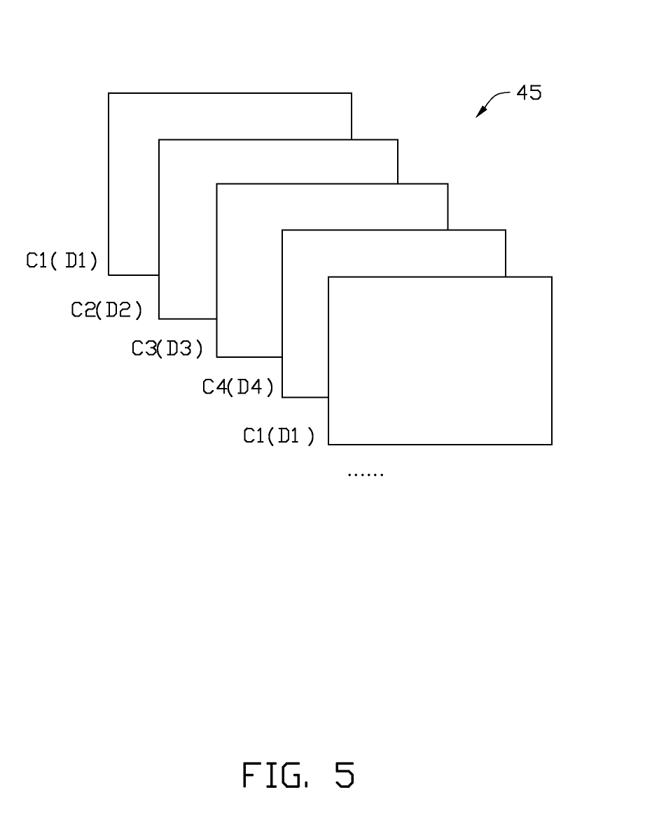

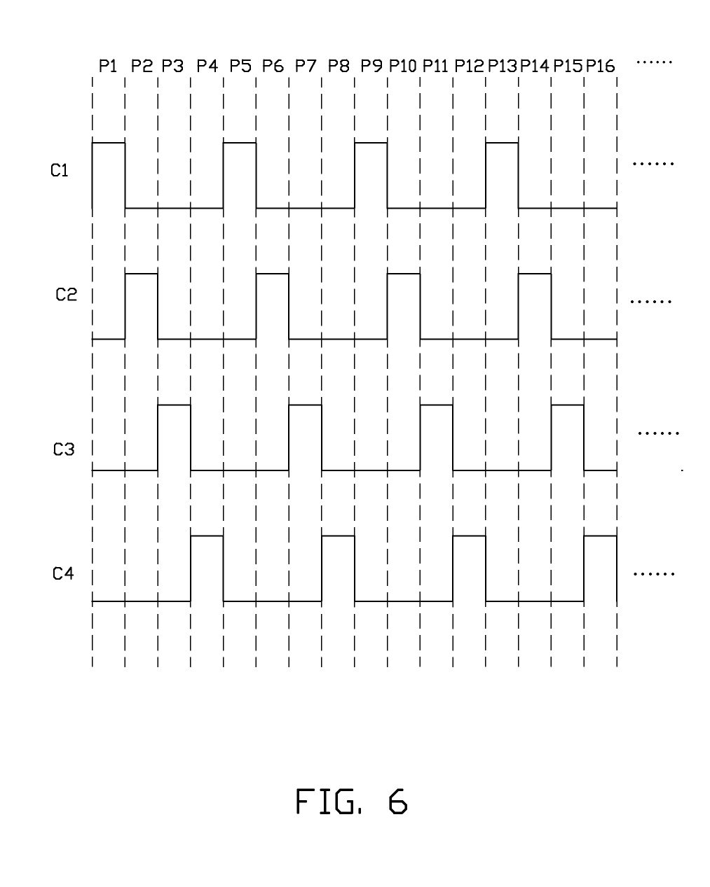

FIG. 5 shows a diagrammatic view of four programs from four different channels displayed by the display system 100 of FIG. 1, according to a second exemplary embodiment. The four programs include first program signals, second program signals, third program signals and fourth program signals. The first program signals include first video signals C1 and first audio signals D1. The second program signals include second video signals C2 and second audio signals D2. The third program signals include third video signals C3 and third audio signals D3. The fourth program signals include fourth video signals C4 and fourth audio signals D4. In this embodiment, the first video signals C1, the second video signals C2, the third video signals C3 and the fourth video signals C4 are integrated into second integrated video signals. The display screen 45 displays the second integrated video signals. In this way, the first video signals C1, the second video signals C2, the third video signals C3 and the fourth video signals C4 are pieced together and are orderly displayed in a sequence according to a second predetermined cycling period. In this embodiment, the second predetermined cycling period is 1/60 seconds, that is, the first video signals C1, the second video signals C2, the third video signals C3 and the fourth video signals C4 are all displayed with a frequency of 60 hertz. In this embodiment, a refresh frame frequency of the display screen 45 is 240 hertz. FIG. 6 is a sequence chart of the first video signals C1, the second video signals C2, the third video signals C3 and the fourth video signals C4. The display screen 45 displays the first video signals C1 during time period P1, P5, P9, P13 . . . P(4n+1), the n in the subscript is a nonnegative integer. The display screen 45 displays the second video signals C2 during time period P2, P6, P10, P14 . . . P(4n+2), wherein the n in the subscript is a non-negative integer. The display screen 45 displays the third video signals C3 during time period P3, P7, P11, P15 . . . P(4n+3), wherein the n in the subscript is a non-negative integer. The display screen 45 displays the fourth video signals C4 during time period P4, P8, P12, P16 . . . P(4n+4), wherein the n in the subscript is a nonnegative integer (the time period P(4n+1), P(4n+2), P(4n+3) and the time period P(4n+4)are not labeled in the figures) The time period P1, P2, P3, P4, P5, P6, P7, P8, P9, P10, P11, P12, P13, P14, P15, P16 . . . P(4n+1), P(4n+2), P(4n+3), P(4n+4)are orderly continuous in a sequence. In this embodiment, each time period (P1, P2, P3, P4, P5, P6, P7, P8, P9, P10, P11, P12, P13, P14, P15, P16 . . . P(4n+1), P(4n+2), P(4n+3), P(4n+4)) lasts 1/240 seconds.

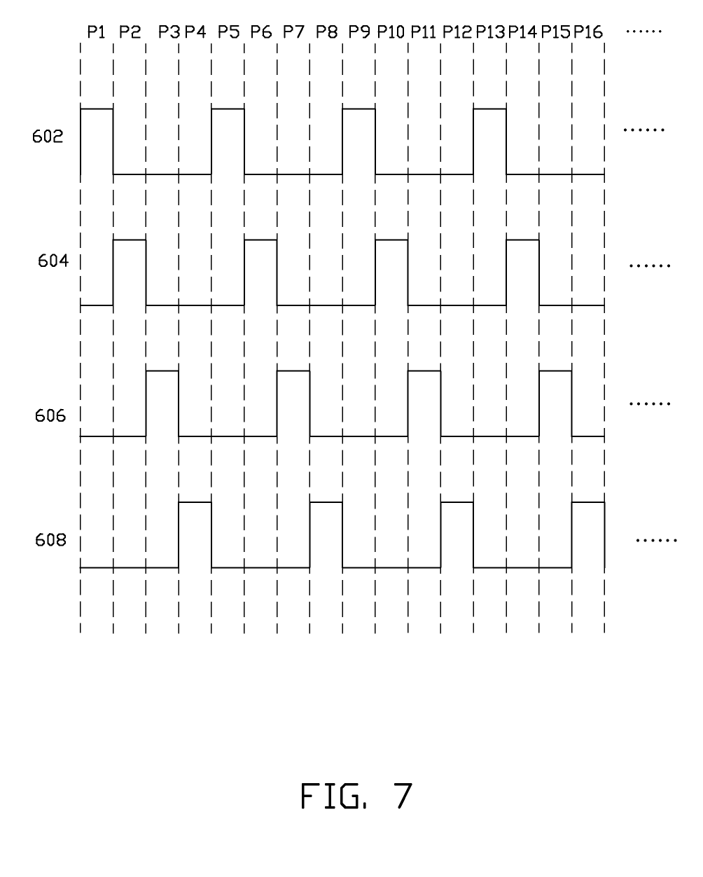

In this embodiment, there are four pairs of shutter glasses accordingly. FIG. 7 is a sequence chart of four pairs of working shutter glasses according to the second exemplary embodiment. The shutter glasses 60 include a first pair of shutter glasses 602, a second pair of shutter glasses 604, a third pair of shutter glasses 606, and a fourth pair of shutter glasses 608. The first pair of shutter glasses 602, the second pair of shutter glasses 604, the third pair of shutter glasses 606 and the fourth pair of shutter glasses 608 open orderly in turn according to the second predetermined cycling period. In detail, the first pair of shutter glasses 602 opens during the time period P1, P5, P9, P13 . . . P(4n+1), the second pair of shutter glasses 604, the third pair of shutter glasses 606 and the fourth pair of shutter glasses 608 are closed during the time period P1, P5, P9, P13 . . . P(4n+1). The second pair of shutter glasses 604 opens during the time period P2, P6, P10, P14 . . . P(4n+2), the first pair of shutter glasses 602, the third pair of shutter glasses 606 and the fourth pair of shutter glasses 608 are closed during the time period P2, P6, P10, P14 . . . P(4n+2). The third pair of shutter glasses 606 opens during the time period P3, P7, P11, P15 . . . P(4n+3), the first pair of shutter glasses 602, the second pair of shutter glasses 604 and the fourth pair of shutter glasses 608 are closed during the time period P3, P7, P11, P15 . . . P(4n+3). The fourth pair of shutter glasses 608 opens during the time period P4, P8, P12, P16 . . . P(4n+4), the first pair of shutter glasses 602, the second pair of shutter glasses 604, and the third pair of shutter glasses 606 are closed during the time period P4, P8, P12, P16 . . . P(4n+4). The first pair of shutter glasses 602 corresponds to the first video signals C1, therefore, a viewer wearing the first pair of shutter glasses 602 can watch the first video signals C1. The second pair of shutter glasses 604 corresponds to the second video signals C2, therefore, a viewer wearing the second pair of shutter glasses 604 can watch the second video signals C2. The third pair of shutter glasses 606 corresponds to the third video signals C3, therefore, a viewer wearing the third pair of shutter glasses 606 can watch the third video signals C3. The fourth pair of shutter glasses 608 corresponds to the fourth video signals C4, therefore, a viewer wearing the fourth pair of shutter glasses 608 can watch the fourth video signals C4. In this embodiment, the processor 30 can output four synchronized signals into the first pair of shutter glasses 602, the second pair of shutter glasses 604, the third pair of shutter glasses 606, and the fourth pair of shutter glasses 608, respectively. Thus, making the first pair of shutter glasses 602 open when the first video signals C1 are being displayed, making the second pair of shutter glasses 604 open when the second video signals C2 are being displayed, making the third pair of shutter glasses 606 open when the third video signals C3 are being displayed, and making the fourth pair of shutter glasses 608 open when the fourth video signals C4 are being displayed. The second predetermined cycling period is short enough that video signals of each program can be seen as being displayed continuously. That is, the viewer wearing one of the four pairs of shutter glasses can see the video signals of a corresponding program being displayed continuously.

The audio module 50 is configured to transmit the first audio signals D1, the second audio signals D2, the third audio signals D3, and the fourth audio signals D4 to the BLUETOOTH™ earphones 70. The BLUETOOTH™ earphones 70 include a first BLUETOOTH™ earphone, a second BLUETOOTH™ earphone, a third BLUETOOTH™ earphone and a fourth BLUETOOTH™ earphone accordingly (the first BLUETOOTH™ earphone, the second BLUETOOTH™ earphone, the third BLUETOOTH™ earphone and the fourth BLUETOOTH™ earphone are not labeled in the figures). The first BLUETOOTH™ earphone is configured to receive the first audio signals D1. The second BLUETOOTH™ earphone is configured to receive the second audio signals D2. The third BLUETOOTH™ earphone is configured to receive the third audio signals D3. The fourth BLUETOOTH™ earphone is configured to receive the fourth audio signals D4. The viewer wearing one of the four pairs shutter glasses should wear the corresponding BLUETOOTH™ earphone.

If the display system 100 displays N programs from N channels (N is a positive integer), and if the predetermined cycling period is 1/60 seconds, then a refresh frame frequency of the display screen 45 should be 60×N hertz.

If the largest refresh frame frequency of the display screen 45 is Q (Q is a positive integer), and if the predetermined cycling period is 1/M seconds, then the display system 100 can display [Q/M] (the number [Q/M] presents a integer number nearest and less than a value of Q/M) programs at most. The parameter M should be no less than 48.

A displaying method for the display system 100 mainly includes the following steps.

The controller 10 receives the control information from viewers and identifies the control information. The control information includes a selection of channels or programs, for example.

The controller 10 controls the signal input module 20 to receive program signals from the selected channels. In this embodiment, the selected channels transmit program signals of different programs at the same time. Each channel transmits both video signals and audio signals. That is, program signals of each channel include both video signals and audio signals.

The signal input module 20 outputs the program signals from the selected channels to the processor 30. The processor 30 processes the program signals from selected channels and integrates the video signals of different channels into integrated video signals and then outputs the integrated video signals to the display module 40. At the same time, the processor 30 processes the audio signals from selected channels and outputs the audio signals to the audio module 50. In the integrated video signals, the video signals of different channels are pieced together and then are orderly integrated into an order sequence according to a predetermined cycling period.

The display module 40 receives the integrated video signals from the processor 30 and displays the integrated video signals. In detail, the display module 40 displays the video signals of different channels orderly in a sequence according to the predetermined cycling period.

The shutter glasses 60 include a number of pairs of shutter glasses. Each pair of shutter glasses corresponds to video signals from a specific channel. When the video signals of the specific channel are displayed, the corresponding pair of shutter glasses open and the other pair of shutter glasses are closed, thus the viewer wearing the corresponding pair of shutter glasses can watch the video signals from the specific channel. In this embodiment, the processor 30 can output a number of synchronized signals into different pairs of shutter glasses, in this way, when video signals of each channel are displayed, the corresponding pair of shutter glasses can open at the same time.

The audio module 50 transmits the audio signals of different channels to the BLUETOOTH™ earphones 70. The BLUETOOTH™ earphones 70 include a number of BLUETOOTH™ earphones corresponding to the audio signals of different channels. Each BLUETOOTH™ earphone is configured to receive the audio signals of a corresponding channel.

The above-described display system includes the processor, the display module and the shutter glasses. The processor can integrate the video signals from the selected channels into integrated video signals, thus the display module can display the video signals of different channels orderly in a sequence according to a predetermined cycling period, and viewers wearing different pairs of shutter glasses can watch their own specific programs. In this way, different viewers can watch different programs from different channels through the same display system at substantially the same time.

Although numerous characteristics and advantages of the present embodiments have been set forth in the foregoing description, together with details of the structures and functions of the embodiment, the disclosure is illustrative only, and changes may be made in detail, including in the matters of shape, size, and the arrangement of parts within the principles of the disclosure to the full extent indicated by the broad general meaning of the terms in which the appended claims are expressed.

What is claimed is:

1. A display system comprising:
a controller configured to receive control information from viewers and identify the control information;
a signal input module configured to receive signals from different channels, each channel transmitting both video signals and audio signals;
a processor configured to receive the video signals and the audio signals of the different channels from the signal input module and process the video signals of the different channels into integrated video signals wherein the video signals of the different channels are pieced together and are orderly integrated into a sequence according to a predetermined cycling period;
a display module configured to display the integrated video signals from the processor, the display module displaying the video signals of different channels orderly in a sequence according to the predetermined cycling period; and
a plurality of shutter glasses corresponding to the video signals of the different channels, when the display module displaying the video signals of one of the channels, the corresponding pair of shutter glasses opening and the other pairs of shutter glasses being closed, the predetermined cycling period is short enough that viewer wearing a corresponding pair of shutter glasses see the video signals of the channel displayed continuously.

2. The display system of claim 1, wherein the display system further comprises an audio module and a plurality of BLUETOOTH™ earphones corresponding to the audio signals of different channels, the processor processes the audio signals of different channels and outputs the audio signals to the audio module, the audio module transmits the audio signals of different channels to the BLUETOOTH™ earphones, each BLUETOOTH™ earphone receives the audio signals from a corresponding channel.

3. The display system of claim 1, wherein the predetermined cycling period is no more than 1/48 seconds.

4. The display system of claim 1, wherein the number of the channels is two, two program from the two channels comprise first program signals and second program signals, the first program signals include first video signals and first audio signals, the second program signals include second video signals and second audio signals, the processor integrates the first video signals and the second video signals into the integrated video signals, the first video signals and the second video signals are pieced together and are orderly displayed in a sequence according to the predetermined cycling period when the display module displays the integrated video signals.

5. The display system of claim 4, wherein the predetermined cycling period is 1/60 seconds.

6. The display system of claim 5, wherein the display module comprises a display screen, a refresh frame frequency of the display screen is 120 hertz, the first video signals are displayed with a frequency of 60 hertz, and the second video signals are displayed with a frequency of 60 hertz.

7. The display system of claim 4, wherein the shutter glasses comprises a first pair of shutter glasses and a second pair of shutter glasses, the first pair of shutter glasses open when the display module is displaying the first video signals, the second pair of shutter glasses open when the display module is displaying the second video signals.

8. The display system of claim 1, wherein the number of the channels is N, the processor integrates the video signals of the N channels into the integrated video signal, the video signals of the N channels are pieced together and are orderly displayed in a sequence according to the predetermined cycling period when the display module displays the integrated video signals.

9. The display system of claim 8, wherein the predetermined cycling period is 1/60 seconds.

10. The display system of claim 9, wherein the display module comprises a display screen, a refresh frame frequency of the display screen is 60×N hertz, video signals of each of the N channels are displayed with a frequency of 60 hertz.

11. The display system of claim 8, wherein the shutter glasses include N pairs of shutter glasses.

12. A displaying method for the display system of claim 1 comprising:
the controller receiving the control information from the viewers and identifying the control information;
the controller controlling the signal input module to receive signals from different channels;
the signal input module outputting the signals of different channels to the processor;
the processor processing the signals of different channels and integrating the video signals of different channels into the integrated video signals and then outputting the integrated video signals to the display module;
the display module receiving the integrated video signals from the processor and displaying the integrated video signals, the display module displaying the video signals of different channels orderly in a sequence according to the predetermined cycling period; and
the corresponding pair of shutter glasses opening when the display module displaying the video signals of one of the channels, and the other pairs of shutter glasses being closed.

13. The displaying method of claim 12, wherein the display system further comprises an audio module, when the processor outputs the integrated video signals to the display module, the processor outputs the audio signals of different channels to the audio module.

14. The displaying method of claim 13, wherein the displaying method further comprises the audio module transmitting the audio signals of different channels.

15. The displaying method of claim 14, wherein the display system further comprises a plurality of BLUETOOTH™ earphones corresponding to the audio signal of different channels, the audio module transmits the audio signals of different channels to the BLUETOOTH™ earphones, each BLUETOOTH™ earphone receives the audio signals from a corresponding channel.
